(19) United States
(12) Patent Application Publication
(10) Pub. No.: US 2018/0204226 A1
(43) Pub. Date: Jul. 19, 2018

(54) END-TO-END SALES WORKFLOW ACCELERATION SYSTEMS AND METHODS

(71) Applicant: LiveHive, Inc., San Jose, CA (US)

(72) Inventors: Suresh BALASUBRAMANIAN, Sunnyvale, CA (US); Frederick Lloyd MUELLER, Los Altos, CA (US); Jonathan Lee BRINK, San Jose, CA (US); An HONG, Fremont, CA (US); Fan YIN, San Jose, CA (US)

(73) Assignee: LiveHive, Inc., San Jose, CA (US)

(21) Appl. No.: 15/866,337

(22) Filed: Jan. 9, 2018

Related U.S. Application Data
(60) Provisional application No. 62/447,238, filed on Jan. 17, 2017.

(51) Int. Cl. G06Q 30/02; G06Q 10/06; G06F 15/18; G06N 5/02

(52) U.S. Cl. CPC G06Q 30/0201; G06Q 10/0633; G06N 5/025; G06Q 10/06316; G06F 15/18; G06Q 10/0637

(57) ABSTRACT

Presented are end-to-end sales acceleration systems and methods that aid sales people in each phase of the sales process to make sales-related decisions that save time and, ultimately, increase revenue. In various embodiments, this is accomplished by monitoring a sales process and taking advantage of a knowledge database and machine learning to provide sales process recommendations, automation, and analytics throughout the entire sales lifecycle. Task identification and automation allows sales people to carry out the recommended tasks in each step of the sales process with less effort, thereby, improving sales efficiency and performance while minimizing cost.

### CROSS REFERENCE TO RELATED PATENT APPLICATIONS

The present application claims priority benefit, under 35 U.S.C. § 119(e), to co-pending and commonly-assigned U.S. Patent Application No. 62/447,238 filed on Jan. 17, 2017, entitled “Systems and Methods for Improving Sales Process Workflow,” and listing as inventors Suresh Balasubramanian, Frederick Lloyd Mueller, Jonathan Lee Brink, An Hong, and Frank Yin, which application is herein incorporated by reference as to its entire content. Each reference mentioned in this patent document is incorporated by reference herein in its entirety.

### TECHNICAL FIELD

The present disclosure relates to information handling systems such as networking devices. More particularly, the present disclosure related to systems and methods for accelerating sales processes.

### DESCRIPTION OF THE RELATED ART

Existing tools that are intended to aid in the management of a sales workflow currently fail to take into account and make use of important activities associated with various phases of the sales workflow. As all phases of the sales workflow are related to each other, it would be desirable to have systems and methods that overcome the shortcomings of the prior art to increase sales productivity.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a sales workflow acceleration system according to various embodiments of the present disclosure.

FIG. 2 illustrates a sales workflow acceleration processor according to various embodiments of the present disclosure.

FIG. 3 is a flowchart of an illustrative process for accelerating a sales process workflow in accordance with various embodiments of the present disclosure.

FIG. 4 depicts a block diagram of an information handling system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

Furthermore, it shall be noted that embodiments described herein are given in the context of sales events, but a person skilled in the art will recognize that the teachings of the present disclosure are not limited to sales applications for salespeople, marketing people, or a customer support person, but may equally be applied in other contexts. Examples of additional applications beyond sales include: political parties communicating with voters, customer support representatives communicating with existing customers regarding a product problem and non-profit organizations communicating with donors about the status of a project they funded.

In this document, the term “prospect” refers to any person of interest to someone using the invention, such as salesperson. “Salesperson” refers to any person using the present invention. As used herein, the terms “action,” “interaction,” and “activity” comprise opening an email or voicemail, viewing an attachment, downloading an attachment, printing an attachment, forwarding an attachment, clicking on a link within an email, replying to an email, an amount of time spent on a page or slide in the attachment, or any combination thereof. It is understood that any one or more of the foregoing is sufficient for the interaction and is not limited to any order. The term “template” refers to pre-constructed email or voicemail templates that may include any type of text, images, web links, and attachments, such as Microsoft Word documents, Microsoft PowerPoint documents, Microsoft Excel documents, Adobe PDF documents, and any other known document format.

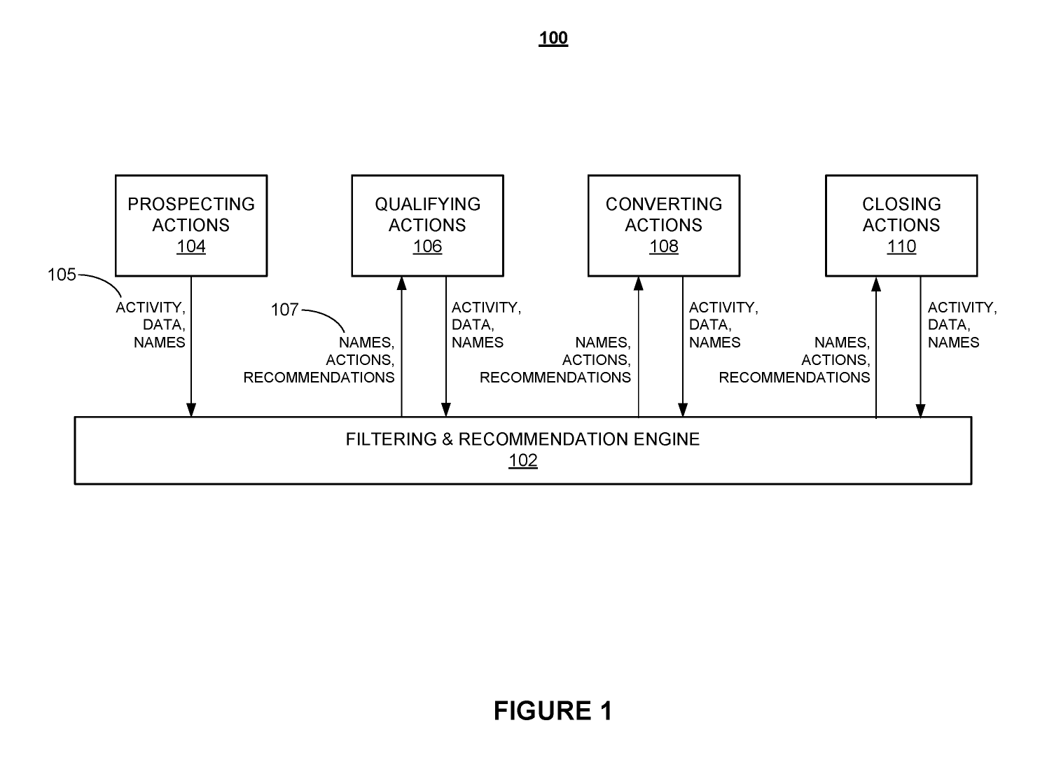

FIG. 1 illustrates a sales workflow acceleration system according to various embodiments of the present disclosure. FIG. 1 depicts various phases or steps 104, 106, 108, 110 of a sales lifecycle that comprise prospecting 104, qualifying 106, converting 108, and closing 110 activities. Prospecting activities 104 comprise deciding, based on given number of names of potential prospects, which ones to focus on, e.g., to contact by email or phone. Qualifying activities 106 comprise opening and replying to an email. Once a potential prospect is identified, e.g., as buyer of widgets, or the potential prospect requests a sales meeting or demonstration, the potential prospect may be qualified. Converting 108 activities comprise converting a qualified prospect to an opportunity, e.g., based on criteria such as the prospect's need for a new or second vendor, the prospect's authority to make a purchase, and the availability of a budget. Finally, closing activities 110 comprise negotiating an agreement with a prospect that has decided to or is prepared to make a purchase, and reporting details of a completed sales activity, such as date, time, and sales amount of a completed sale.

Steps 104, 106, 108, 110 are associated with activity data 105 that is used by filtering and recommendation engine 102. In embodiments, filtering and recommendation engine 102 provides predefined sales-related tasks, e.g., specific actions a salesperson may take regarding each prospect at various stages in the sales process, such as communicating by using predefined phone call scripts and email templates, e.g., an email template that comprises an attached document.

In embodiments, automation allows sales people to carry out the recommended tasks associated with each step 104, 106, 108, 110 in the sales process with a minimum of effort. Activity data 105 by the prospect and or the salesperson is used to make recommendations regarding how each phase 104, 106, 108, 110 may be incrementally optimized. It is understood that, at any time, the sales tasks may be made available as a resource to sales people, whether a task has been recommended or not.

In embodiments, once executed, information about sales tasks is recorded and stored along with additional sales task-related information, such as an identifier identifying the sales task (e.g., ID of an email template); a sales stage of the prospect (e.g., qualifying stage); a stage outcome (e.g., prospect was marked as “qualified”); a prospect profile—title, company, industry, etc.; Sales outcome (e.g., successful sale and sales amount); salesperson(s) associated with the account. In addition, the manner in which a sales task is used, e.g., a particular email template, may be monitored and recorded, e.g., to determine the success or failure associated with the specific use of that task, e.g., as measured by whether a prospect associated with that particular sales task and product made a purchase.

Sales task-related data may be used by any machine learning process known in the art, e.g., Reinforcement Learning that attempts to base future decisions on previously successful decisions. In embodiments, machine learning is implemented in the filtering and recommendation engine 102 to provide increasingly accurate results as more data is created over time. In embodiments, recommendation engine 102 dependent on the data so the algorithms in the recommendation can be improved over time based on the same data.

In each phase 104, 106, 108, 110, connectors to third party companies may be used to receive information that may be useful in a particular sales step 104, 106, 108, 110. In embodiments, external data received from a third party may be augmented with the sales prospect feedback data that comprises prospecting activities 104, such as opening an email, viewing an attachment, making a phone call, etc., that are analyzed to generate a measure for the sales potential associated with a prospect.

In embodiments, activity data 105 is used in one or more phases to identify the best lead source or to generate an overall measure the efficiency of the sales process. A closing module may automate steps to close a sale. Closing a sale is typically the most complicated step in the sales process and may involve the most steps and the greatest number of people. Consequently, automation provides a key benefit by helping the salesperson efficiently manage a large number of tasks.

In embodiments, filtering and recommendation engine 102 uses machine learning to refine recommendations over time. Each time a prospect successfully moves to the next sales stage 104, 106, 108, 110 or fails to do so, filtering and recommendation engine 102 receives information about the details and results of a particular sales action. For example, if a particular recommendation achieves a desired outcome regarding one prospect having a particular profile but fails to achieve the desired outcome regarding another prospect having a different profile, this information may be used to refine recommendation regarding sales actions that filtering and recommendation engine 102 may recommend for different prospects and/or in a subsequent stage 104, 106, 108, 110.

In embodiments, machine learning improves recommendations 107 associated with prospects based on an increasing volume of sales data that improves the accuracy of the analytics. System 100 may reinforce and improve on a company's best practices that may start with the company's self-defined sales processes. Filtering and recommendation engine 102 learns from each sales success or failure to improve the recommendations. This ability to improve the entire sales process is made possible by an end-to-end data driven view of the sales process that takes into consideration the outcomes of sales activities for each prospect and monitors which recommendations 107 in each stage 104, 106, 108, 110 were helpful.

In embodiments, recommendations 107 may be customized based on information regarding different products a company sells such that recommendations 107 are not generic to any sales scenario but rather customized and maybe incrementally improved for specific products a company offers.

In embodiments, filtering and recommendation engine 102 may receive activity data 105 regarding actions taken by sales people across a company, such that the set of data that may be considered and cross-correlated is larger than a set of data that accounts only for the experience of individual sales people.

In embodiments, filtering and recommendation engine 102 uses a success blueprint to ensure that the most important sales actions are recommended for each stage 104, 106, 108, 110 in the sales process. The success blueprint is, for example, a specific analytic that identifies actions that are most common to a successful sale.

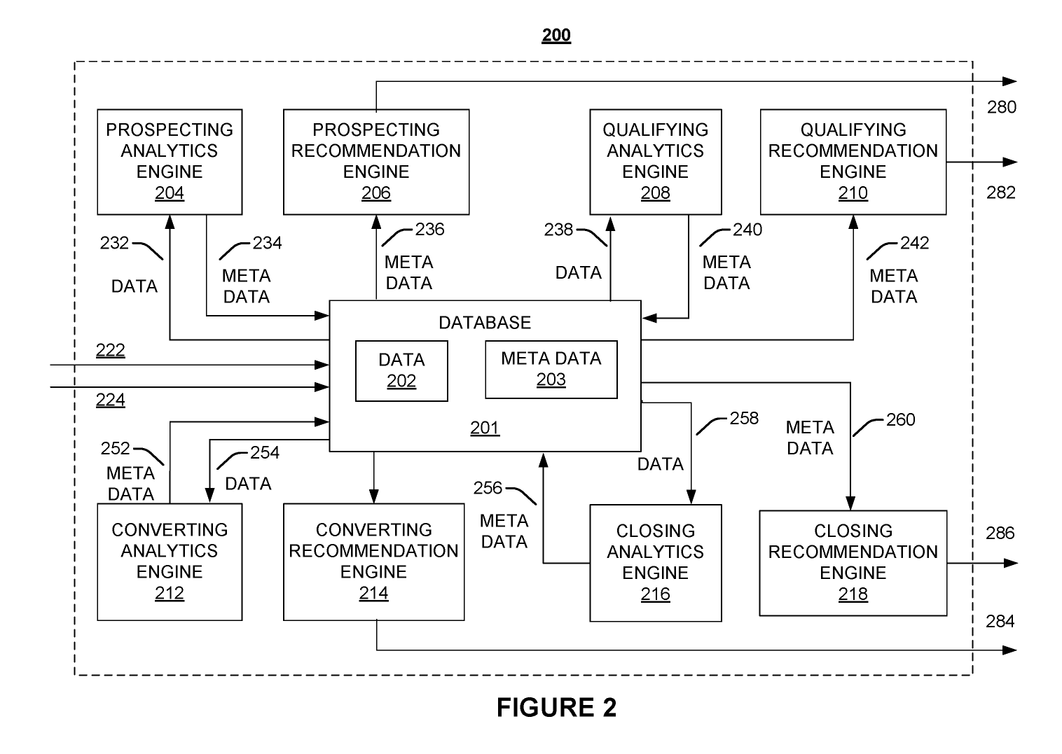

FIG. 2 illustrates a sales workflow acceleration processor according to various embodiments of the present disclosure. Processor 200 comprises prospecting analytics engine 204; prospecting recommendation engine 206; qualifying analytics engine 208; qualifying recommendation engine 210; conversion analytics engine 212; converting recommendation engine 214; closing analytics engine 216; closing recommendation engine 218; database 201 that may comprise data storage 202, and meta data database 203. It is understood that database 201 may be any database known in the art, such as a distributed database.

In embodiments, a list of contact data 222, such as names and activities is input into processor 200, e.g., via an API. Contact data 222 may be imported, e.g., as text file, from one or more data sources, such as an external sales automation, marketing automation, or data services companies. In embodiments, contact data 222 is imported based on search criteria, e.g., minimum company size, job titles, and other information related to contacts. Prospecting recommendation engine 206 may make initial recommendations about the search criteria prior to receiving contact data 222, e.g., from a third party, and may also recommend suitable data sources for different types of searches. As an example, one data source may work best for finding contacts having a VP of Finance job title, while a different data source may be better suited to find contacts having a job title of VP of R&D. In embodiments, prospecting recommendation engine 206 iteratively aggregates historical data to identify contact profiles, to enable search by job title, industry, and the like.

Prospecting analytics engine 204, retrieves contact data 222 from storage 202 and, in embodiments, and evaluates contact data 222 to identify the most relevant contact profiles, e.g., based on sales potential. A contact profile may include a contact's title, industry, company, and company details, such as revenue and number of employees. In embodiments, prospecting analytics engine 204 generates metadata 234 based on the contact profile, e.g., in the form of a selected subset of contact data 222, and stores metadata 234 in meta data database 203 for use by prospect recommendation engine 206.

In embodiments, prospect recommendation engine 206 retrieves from meta data database 203 some or all of metadata 234 that comprises a list of names of potential prospects, and assigns one or more recommended steps 280 to members of the list.

Recommended steps 280 may comprise a sequence of sales actions, such as sending predefined emails and phone calls. Different potential prospects or contacts may be assigned different sequences, for example, based on a particular sales campaign or a particular characteristic of the contact itself (title, company size, etc.). In embodiments, prospecting recommendation engine 206 assigns a sequence to a contact profile based on previous sales data. In embodiments, the sequence of recommended steps 280 is selected in a manner such as to increase the likelihood of qualifying the potential prospect a step toward successfully completing a sale.

An exemplary prospecting sequence may have several steps that may include sending an introductory email, sending an email having a useful attachment, making a phone call as a follow-up step to the sent email, and a request for a phone call for the purpose of finding out more about the contacted prospect's needs in reparation for the qualification process.

When recommended steps 280 involve sending email(s), in embodiments, an automation module (not shown) may be employed to automatically send emails, e.g., according to a predetermined schedule. Similarly, when recommended steps 280 involve placing a phone call, the automation module may schedule a call task and, for example, send text a reminder to a salesperson a few minutes before the scheduled call time.

In embodiments, once prospecting activities are executed according to recommended steps 280, the results of these sales activities associated with contact data 222 are fed back into processor 200 and stored in database 201. The results may suggest, for example, that some potential prospects show a greater level of interest or engagement than others. This and any other information generated or received by processor 200 may be used by prospecting analytics engine 204 when scoring potential prospects to identify those with the highest sales potential.

A qualifying process provides a salesperson with information that is helpful in identifying which prospects meet certain pre-defined criteria for qualifying a prospect so that the prospect may be designated as “qualified” or “not qualified,” e.g., based on company specified criteria. A typical criterion may be that “the prospect company has a need for the product.”

In embodiments, qualifying analytics engine 208 receives from metadata database 203 prospect activity data 238 associated with prospects identified by prospecting analytics engine 204, and determines prospects that are likely to be qualified. In embodiments, prospecting analytics engine 204 generates metadata 240 comprising prospect information, e.g., in form of a list comprising names, and stores the prospect information in meta data database 203. In embodiments, qualifying analytics engine 208 retrieves from meta data database 203 the prospect information, including a list of potentially qualifying prospects, and makes a determination on the likelihood that a prospect is qualified. In embodiments, for some prospects, qualifying analytics engine 208 allows a salesperson to make a final determination on whether a prospect is qualified or not.

In embodiments, qualifying recommendation engine 210 uses the meta data database 242 that comprises some or all of the prospect information to generate and output qualifying recommendations 282 regarding sales tasks that should be taken to quickly and efficiently qualify a prospect. In embodiments, recommendations 282 are based on prospect activity data 238. For example, activity data indicating that a prospect opened and read a received attachment that describes a product may be used to infer that the prospect has a possible need for that product. In embodiments, qualifying recommendation engine 210 makes rule-based inferences based on any type of activity data, e.g., results of an online survey that a prospect took.

It is noted that the qualifying process may be more than a simple “yes” or “no” answer to a question. In embodiments, recommendations are based on analytic scores that are generated by qualifying analytics engine 208. Further, analytic scores may be adjusted over time. For example, a prospect may not realize a need for a product until receiving an explanation about the product, or a salesperson may have to learn about the inner workings of a company before a need can be determined.

Qualifying recommendations 282 may comprise one or more tasks. For example, a task directed to a salesperson to call a prospect, a suggested time to make the phone call, and a suggested content for the call, e.g., qualifying questions from a predefined call script. Other examples of qualifying recommendations 282 include: sending a prewritten email to the prospect to inquire about the prospect's level of interest in a product; sending a particular attachment to the prospect to elicit further engagement; scheduling a product demonstration /meeting to decide whether a prospect has a need for a product. In embodiments, a prospect may be assigned a particular qualifying task sequence.

In embodiments, an automation module may be used to execute the recommended steps. For example, if a recommended step involves sending an email, the automation module may automatically schedule and send any number of emails at appropriate times. If the recommended step is to place a phone call, the automation module may schedule a call task and text a reminder to the salesperson shortly before they scheduled phone call.

In embodiments, the results of the qualifying activities are used to determine, e.g., based on a scoring system, a list comprising candidates that have the greatest potential for a sale, i.e., candidates that are categorized as “qualified.” The list may be stored in meta data database 203 as a list of qualified prospects for use by conversion analytics engine 212.

A qualified prospect may be converted to an opportunity if the prospect has a need that for a salesperson's product, the prospect has purchasing authority, and a sufficient budget. In embodiments, the conversion process for a prospect uses converting analytics engine 212 to retrieve from metadata database 203 prospect activity data 254 that is associated with a number of qualified prospects. In embodiments, based on the prospect activity data 254, converting analytics engine 212 determines which prospects are likely candidates to be converted and stores a list 252 of identified potential prospects in meta data database 203.

To convert a prospect to an opportunity and generate list 252, in embodiments, converting analytics engine 212 assigns scores qualified prospects based on criteria that may be developed by the company. Examples of such criteria are: 1) Budget—A budget exists to purchase the product and it is large enough to meet a minimum monetary size or volume criterion; 2) Need—The prospects company has a verified need for the product; and 3) Authority—The contact has the authority to manage the sales process for the purchasing company.

In embodiments, converting recommendation engine 214 recommends the conversion steps that should be taken for prospects that have been designated as qualified 242, e.g., by qualifying recommendation engine 210. Determining whether to convert a qualified prospect to an opportunity may involve a more complicated process that determining whether a prospect is qualified. For example, selection criteria may be stricter, take more time, and require a higher number of steps to be performed. In embodiments, converting recommendation engine 214 may generate one or more recommendations, such as specific sales tasks, based on analytics provided by converting analytics engine 212.

In embodiments, converting recommendation engine 214 generates recommendations that may be based on known information regarding a prospect, e.g., title, company, industry, etc. Recommendations may also be based on the analytics scores generated as the result of previous emails and phone calls from the prospect and qualification steps. Converting recommendation engine 214 may find information about prospects that resulted in a successful conversion in the past. This information may be used to identify and recommend actions 284 that are more likely to result in converting a current prospect.

Examples of converting recommendations 284 comprise activities such as 1) immediately calling a prospect and asking questions based on a predefined call script, e.g., a script prepared by the company; 2) assigning the prospect a particular task sequence involving two or more tasks, such as answering questions received via email; 3) holding a live in-person or online meeting; and 4) giving a product demonstration.

As with prospecting and qualifying, any number of recommended steps 284 may be partially or fully automated (e.g., sending emails) or automation may be used to improve the planning and execution of tasks (e.g., scheduling a reminder for salesperson regarding telephony tasks).

In embodiments, upon completion of one or more conversion activities according to recommended steps 284, a salesperson and/or processor 200 may enter the results of a salesperson/processor 200 following recommended sales activities 284 back into processor 200, e.g., into contact data 222, such that, e.g., in a later iteration, converting analytics engine 212 may score potential conversion prospects to better identify those having the highest sales potential. In embodiments, based on the result of the conversion activities 284, some prospects are designated as an “opportunity” while and others may be designated as “no opportunity.”

In embodiments, in addition to activity data, converting analytics engine 212 uses third party data, e.g., when scoring potential conversion prospects. Third party data may comprise, for example, information that a company is undergoing relatively fast revenue growth and, thus, has a higher probability being a candidate for buying products and services that are needed to support that growth compared to a company with shrinking revenue.

An opportunity will close either as a successful or unsuccessful sale. Typically, a purchase order will result from a successful sale, and the amount of the purchase order may be used as a measure of the magnitude of that success. In embodiments, closing recommendation engine 218 may be used to recommend sales steps that should be taken for to obtain sales orders from converted prospects. Closing recommendation steps 286 comprise sales tasks generated by closing recommendation engine 218. Closing a sale may be the most complicated stage in the sales process, e.g., because the salesperson may need approval from multiple people at the prospect's company before receiving a purchase order, and may need to follow a complicated sales contract review and signing procedure. In embodiments, recommendations 286 are based on analytic scores generated by closing analytics engine 216 and/or steps associated a “success blueprint.” In embodiments, a success blueprint comprises a breakdown of the steps that in the past and for a similar opportunity led to a successful sale. In embodiments, the success blueprint is used as a starting point for closing recommendation engine 218 when recommendation steps 286.

Examples of closing recommendations comprise steps such as calling a prospect and identifying specific obstacles to a sale (closing recommendation engine 218 may then, in embodiments, suggest a follow up step based on the identified obstacle. Examples of obstacle comprise 1) a specific competitor that the prospect considers, 2) budget constraints, and 3) ROI concerns.

In embodiments, a follow up to recommendation steps 286 may comprise 1) holding a presentation that outlines advantages vis-a-vis a competitor or provides ROI justifications; 2) scheduling a product demonstration to decide whether the prospect needs the product; 3) sending a custom email referencing a recent announcement from the prospect's company, e.g., a note of congratulations when a new product is announced; 4) assigning a particular closing task sequence to the prospect.

The closing process usually involves steps such as the following: security and compliance evaluation; technical sign off; acceptance from a buying committee; price negotiation; and purchase contract signoff.

Any of these steps may require input from additional people in the salespersons company as well as existing or custom documents that are shared with the prospect.

Recommended steps 286 for closing a sale may be automated. Recommended emails and phone calls may be automatically scheduled. Emails may be sent automatically, and telephony features may automate at least portions of the calling process. In embodiments, when meetings are required to perform certain tasks, such as a Security and Compliance Evaluation, processor 200 may coordinate two or more schedules to automatically schedule the meeting. If a specific sales obstacle, such as a comparison with a competitor, has been identified, an email with a comparison document may be sent. In embodiments, sales contracts and other documents that require signatures may be routed via an online document management to request electronic signatures.

In embodiments, once a sale closes, either with an order or without an order having been placed, closing analytics engine 216 may retrieve from database 201 information related to the monitored and saved sales activities and results of sales efforts to generate or update, e.g., in combination with a machine learning algorithm, scores for the contact list sources and/or Success Blueprints, and save the result in meta-data database 203.

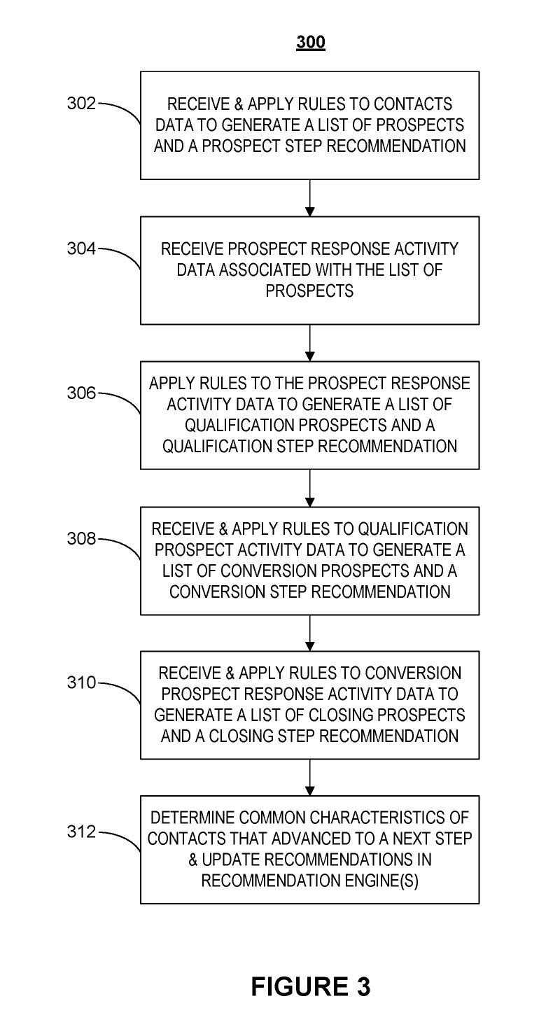

FIG. 3 is a flowchart of an illustrative process for accelerating a sales process workflow in accordance with various embodiments of the present disclosure. Process 300 begins at step 302, when contacts data is received (e.g., based on search criteria) and rules are applied to the contacts data to generate a list of prospects and recommend steps associated with the prospects. The contacts data may be imported from a third-party database and comprise names other information about contacts.

At step 304, prospect response activity data associated with the list of prospects is received.

At step 306, rules are applied to the prospect response activity data to generate a list of qualification prospects and a qualification step recommendation.

At step 308, qualification prospect activity data is received and rules are applied to the qualification prospect activity data to generate a list of conversion prospects and a conversion step recommendation.

At step 310, conversion prospect response activity data is received and rules are applied to the conversion prospect response activity data to generate a list of closing prospects and a list of closing step recommendation.

At step 312, common characteristics of contacts that successfully advanced to a next step are determining, e.g., based on a comparison of data associated with one of the contacts that closed sales; and, based on the common characteristics, recommendations in one or more recommendation engines are adjusted or updated.

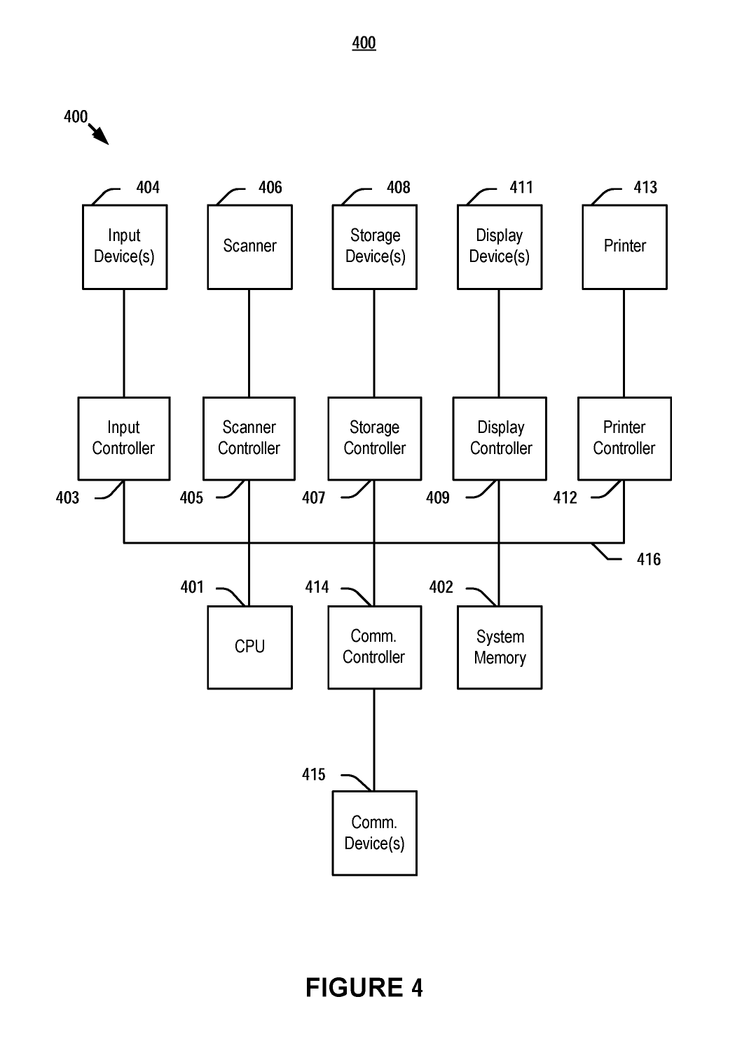

FIG. 4 depicts a block diagram of an information handling system 1000 according to embodiments of the present invention. It will be understood that the functionalities shown for system 400 may operate to support various embodiments of an information handling system—although it shall be understood that an information handling system may be differently configured and include different components. As illustrated in FIG. 4, system 400 includes a central processing unit (CPU) 401 that provides computing resources and controls the computer. CPU 401 may be implemented with a microprocessor or the like, and may also include a graphics processor and/or a floating point coprocessor for mathematical computations. System 400 may also include a system memory 402, which may be in the form of random-access memory (RAM) and read-only memory (ROM).

A number of controllers and peripheral devices may also be provided, as shown in FIG. 4. An input controller 403 represents an interface to various input device(s) 404, such as a keyboard, mouse, or stylus. There may also be a scanner controller 405, which communicates with a scanner 406. System 400 may also include a storage controller 407 for interfacing with one or more storage devices 408 each of which includes a storage medium such as magnetic tape or disk, or an optical medium that might be used to record programs of instructions for operating systems, utilities and applications which may include embodiments of programs that implement various aspects of the present invention. Storage device(s) 408 may also be used to store processed data or data to be processed in accordance with the invention. System 400 may also include a display controller 409 for providing an interface to a display device 411, which may be a cathode ray tube (CRT), a thin film transistor (TFT) display, or other type of display. The computing system 400 may also include a printer controller 412 for communicating with a printer 413. A communications controller 414 may interface with one or more communication devices 415, which enables system 400 to connect to remote devices through any of a variety of networks including the Internet, an Ethernet cloud, a Fiber Channel over Ethernet (FCoE)/Data Center Bridging (DCB) cloud, a local area network (LAN), a wide area network (WAN), a storage area network (SAN) or through any suitable electromagnetic carrier signals including infrared signals.

In the illustrated system, all major system components may connect to a bus 416, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It shall be noted that elements of the claims, below, may be arranged differently including having multiple dependencies, configurations, and combinations. For example, in embodiments, the subject matter of various claims may be combined with other claims.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A method for accelerating a sales process workflow to increase sales productivity, the method comprising:
in response to receiving contact data, generating a list of prospects and a recommendation step that is associated with at least a part of the list of prospects;
in response to receiving prospect response activity data associated with one or more prospects, generating a qualification step recommendation and a list of qualification prospects;
in response to receiving qualification prospect activity data associated with the contact data, generating a list of conversion prospects and a conversion step recommendation; and
in response to receiving conversion prospect response activity data associated with the contact data, generating a list of closing prospects and a closing step recommendation.

2. The method according to claim 1, further comprising, based on a common characteristic between the two or more contacts, adjusting at least one of the recommendation step, the qualification step recommendation, the conversion step recommendation, and the closing step recommendation.

3. The method according to claim 1, comparing data associated with the two or more contacts that closed at least one sale to determine the common characteristic between the two or more contacts.

4. The method according to claim 1, further comprising importing the contact data from a third-party database.

5. The method according to claim 1, wherein the contact data comprises information about at least some of the two or more contacts.

6. The method according to claim 1, wherein the recommendation step comprises a sales activity.

7. The method according to claim 1, further comprising selecting the contact data based on at least a search criterion.

8. A system for accelerating a sales process workflow to increase sales productivity, the system comprising:
one or more processors; and
a non-transitory computer-readable medium or media comprising one or more sequences of instructions which, when executed by at least one of the one or more processors, causes steps to be performed comprising:
in response to receiving contact data, applying rules to the contact data to generate a list of prospects and a recommendation step that is associated with at least some prospects in the list of prospects;
in response to receiving prospect response activity data associated with one or more prospects, applying rules to the prospect response activity data to generate a qualification step recommendation and a list of qualification prospects;
in response to receiving qualification prospect activity data, applying rules to the qualification prospect activity data to generate a list of conversion prospects and a conversion step recommendation; and
in response to receiving conversion prospect response activity data, applying rules to conversion prospect response activity data to generate a list of closing prospects and a closing step recommendation.

9. The system according to claim 8, wherein the contact data is received from a database that comprises meta-data.

10. The system according to claim 8, wherein the common characteristic is determined based on a comparison of data associated with two or more contacts that closed at least one sale.

11. The system according to claim 10, wherein the recommendation step is adjusted based on a common characteristic between the two or more contacts.

12. The system according to claim 8, wherein the contact data has been selected based on at least one search criterion.

13. The system according to claim 8, wherein the contact data has been imported from an external database and comprises information about at least some of the contacts.

14. A system for accelerating a sales process workflow to increase sales productivity, the system comprising:
a database to receive and store meta-data that is associated with contact data;
a plurality of analytics engines coupled to the database to generate at least some of the meta-data; and
a plurality of recommendation engines coupled to the database, the recommendation engines makes rule-based inferences associated with the contact data and outputs recommendations related to a sales activity.

15. The system according to claim 14, wherein at least one of the recommendations is adjusted or updated based on a common characteristic between two or more contacts.

16. The system according to claim 14, wherein the plurality of analytics engines comprises at least one of a prospecting engine, a qualifying engine, a converting engine, and a closing analytics engine.

17. The system according to claim 14, wherein the plurality of recommendation engines comprises at least one of a prospecting recommendation engine, a qualifying recommendation engine, a converting recommendation engine, and a closing recommendation engine.

18. The system according to claim 15, wherein the prospecting recommendation engine is configured to generate a sequence of sales actions.

19. The system according to claim 14, wherein the recommendations are based on analytical scores that are associated with one or more predetermined criteria.

20. The system according to claim 14, further comprising an automation module that is configured to execute one or more of the recommendations.
